(19) United States
(12) Patent Application Publication
(10) Pub. No.: US 2005/0151644 A1
(43) Pub. Date: Jul. 14, 2005

(54) Method of defense-in-depth ultrasound intrusion detection

(75) Inventors: Robert Henry Roche, Westminster, MD (US); Vadym Buyalsky, Reisterstown, MD (US); Vladimir Herman, Montgomery Village, MD (US)

Correspondence Address: Robert H. Roche;Suite H, 1004 Littlestown Pike, Westminster, MD, 21157-3026, US

(73) Assignee: CTRL Systems, Inc., Westminster, MD (US)

(21) Appl. No.: 10/754,800

(22) Filed: Jan. 9, 2004

(51) Int. Cl. G08B 13/18

(52) U.S. Cl. 340/552; 367/93

(57) ABSTRACT

Method of ultrasound intrusion detection is disclosed wherein the ultrasound multi-area volumetric surveillance is being organized to meet properly the correspondent requirements for the defense-in-depth protection of critical objects. All the room around a protected object is being purposely arranged in juxtaposed volumetric areas, which areas are closed or open and do represent respectively the central, short-range and long-range echelons of an entire defense-in-depth protection space. The pertain method of ultrasound detection of either ingress or aggress hazardous intrusion is being realized in each adjacent echelon regarding the specific task, which this very echelon has been commissioned with. These methods are being based preferably upon the reflection, refraction and interference of narrowly directed ultrasound beams, which beams are being closely disposed in 2-D curvilinear array or 3-D curved surface arrangement and activated for target detection with use of either stationary vector directing or scan conversion techniques. Processing and displaying of self-checking, caution and alarm signals are being accomplished on the basis of logical programming and with the same kind of hardware and software for each method of ultrasound detection involved that shall enhance the reliability, trustworthiness and cost-effectiveness of ultrasound detection of ingress or aggress intrusion throughout the adjacent volumetric protection areas of critical objects.

### FIELD OF THE INVENTION

The invention relates to the acoustic wave methods and systems for presence or movement detection and for distance or direction finding in the case of having a plurality of ultrasound type transmitter and receiver transducers. In particular this invention refers to condition responsive early indicating systems that exploit the registration of an occasional disturbance of ultrasonic wave beams in the manner of their reflection, refraction and interference created by either an intruding subject or a trespasser.

### BACKGROUND OF THE INVENTION

At the present there exist methods and systems of ultrasound intrusion detection in an entire volumetric surveillance areas, in which areas there are being used different arrangements of transmitting and receiving transducers, at least namely:
fan-shaped or matrix arrangements of transmitter and receiver transducers for stationary vector directing surveillance, e.g. U.S. Pat. Nos. 5,920,521 and 4,582,065 respectively;
solitary arrangement of transmitter-receiver couples for scanning all over the surveyed area with narrow clusters of ultrasound beams, e.g. U.S. Pat. Nos. 4,644,509; 5,309,144;
multi-seat arrangement of receivers along the perimeter of protected area for detecting an occurrence of ingress or aggress intrusion thru the vicinity of protected area perimeter, e.g. U.S. Pat. No. 5,483,224;
single-row or multi-row arrangement of transmitting and receiving transducers for realizing various processing operations with the help of reflected ultrasound beams, in particular:
detection any strange subject inside the surveyed area, e.g. U.S. Pat. Nos. 5,761,155 and 6,518,915B2;
measurement of distance to intruded subjects or to the level of interface of liquid and granular materials, e.g. U.S. Pat. Nos. 4,949,074, 5,231,608 and 5,131,271, 6,323,441B1 respectively;
isolated arrangement of transmitter inside an enclosed area and positioning the receiver outside this enclosed area with the aim of detecting an occurrence of destroying the isolation of said protected area by an intruder, e.g. U.S. Pat. Nos. 4,807,255, 5,638,048, 6,430,988.

As is evident from the delivered above the elucidative examples, the modem methods and systems for ultrasound intrusion detection utilize preferably the phenomenon of reflection of ultrasound beams from strange subjects that have occurred inside a surveyed area. Meanwhile, it is the known fact that the process of emitting-reception of airborne ultrasound signals depends strongly upon air ambient conditions (temperature, moisture, atmospheric pressure, etc.) and therefore it is restricted spatially. In turn, this restriction predicts the limitations upon volumetric dimensions of surveyed area and consequently on the capability of earlier warning detection of either an intruding object or a trespasser. The alternative enhancement of the entire protected space might be realized by attaching to the ultrasound-surveyed area the proper number of adjacent areas, which areas were being surveyed with use of different principles of intrusion detection (infrared, microwave, light level sensing, etc.), e.g. see U.S. Pat. Nos. 4,857,912 and 6,127,926. Unfortunately, such a would-be method and arrangement will lead to hardware and software complexity, low reliability and great cost of an intrusion protection system as a whole. Nevertheless, it is necessary to establish such very method of intrusion protection that features with high reliability and self-security, and meets the proper requirements to the protection systems of critical objects. Those crucial requirements are delivered at least in the following regulations for such evidently critical objects as Nuclear Power Plants:
Defense-in-Depth in Nuclear Safety, IAEA INSAG-10, IAEA, Vienna, 1996.
Method for Performing Diversity and Defense-in-Depth Analysis of Reactor Protection Systems. NUREG for U.S.NRC/Prepared by G. G. Preckshot-Lawrence Livermore National Laboratory/Manuscript date: December 1994.

Furthermore, it seems to be relevant to emphasize some unique features of ultrasound that make it attractive for the purpose of intrusion protection, namely:
ultrasound waves are being emitted in the form of narrow directional beam and consequently do not travel around corners well, so said directional beam may be easily reflected and/or shielded by an intruded subject;
narrow spatial angle directional reception of airborne ultrasound may be obtained with relatively small dimensions of hidden receivers;
ultrasound is not influenced by regular “white noise” of an environment, especially by an industrial ambient, being either inside or outside.

Besides, at the present time the ultrasound processing methods and instruments are being well practiced in even multi-modular hierarchical detecting systems that contain the similar ultrasonic instrumentation and hence are reliable, convenient and low-cost. This processing advancement is the actual prerequisite for improving an intrusion protection with use of ultrasound technology.

### SUMMARY OF THE INVENTION

With the aim of proper introducing into the art the mentioned above relevant specifity of ultrasound technology, it is necessary to identify the new basic objects of concern.

The principle object of the present invention is to establish a method of anticipatory ultrasound intrusion detection that enables the purposeful application of all the advantageous features of ultrasound technology for arranging the reliable early and preventive defense-in-depth ingress or aggress intrusion detection process in the limits of multi-echelon dome-type volumetric space around a surveyed critical installation.

Other object of the invention is to arrange the whole protected dome-type volumetric room around a critical installation in several juxtaposed areas, which areas represent various echelons of the entire defense-in-depth intrusion detection volumetric space.

Further object of the invention is to choose properly the geometrical shapes and dimensions of these 2-D curvilinear or 3-D curved surface areas in correspondence with the spatio-temporal parameters of air-borne ultrasound propagation and the available capabilities to cover all the said 2-D curvilinear or 3-D curved surfaces with stationary or scanning the relevant ultrasound beam patterns.

Another object of the invention is to compose a graphic-analytical model of intrusion vulnerability for each echelon, taking to consideration the options of spatio-temporal purposeful behavior of intruder or trespasser.

The other object of the invention is to choose and assign for each echelon the appropriate method of ultrasound intrusion detection regarding the type of ultrasonic beam responding, i.e. reflection, refraction and interference created by predetermined behavior of either an intruding subject or a trespasser.

The further object of the invention is to compose the generalized graphic-analytical model of intrusion vulnerability for entire protected dome-type volumetric space around a critical installation. This model must properly establish an operatively reliable and functionally correct interrelation amongst different adjacent echelons based on the principle of early and preventive ultrasound detection of ingress or aggress intrusion.

Still further object of the invention is to minimize the diversity of hardware and software of all techniques of ultrasound intrusion detection involved, and to compose finally the mutual set of instruments and logic software for entire defense-in-depth intrusion detection procedure.

The specific content of the invention, as well as other objects and advantages thereof, will clearly appear from the following description and accompanying figures.

### BRIEF DESCRIPTION OF THE FIGURES

Preferred embodiments of the present invention will now be described with reference to the figures by way of illustration, in which the fundamentals of the suggested novel method of ultrasound multi-echelon intrusion detection are represented, in which like reference characters indicate like elements of method arrangement, in which explanations of said arrangement are given, and in which:

FIG. 1 shows schematically an alternative embodiment of a defense-in-depth ultrasound multi-echelon intrusion detection space structure that, accordingly to the present invention, has been arranged in possession of juxtaposed the in-built, short-range and long-range areas. These areas principally represent the corresponding echelons of said ingress or aggress ultrasound intrusion detection with various types of ultrasound beam response.

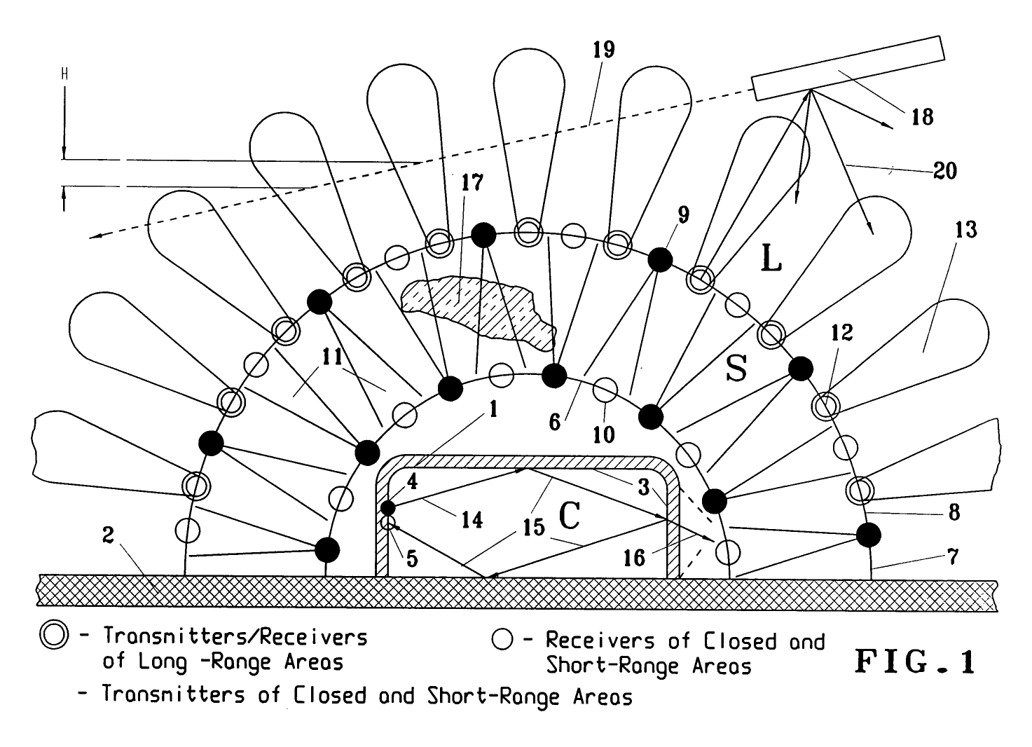

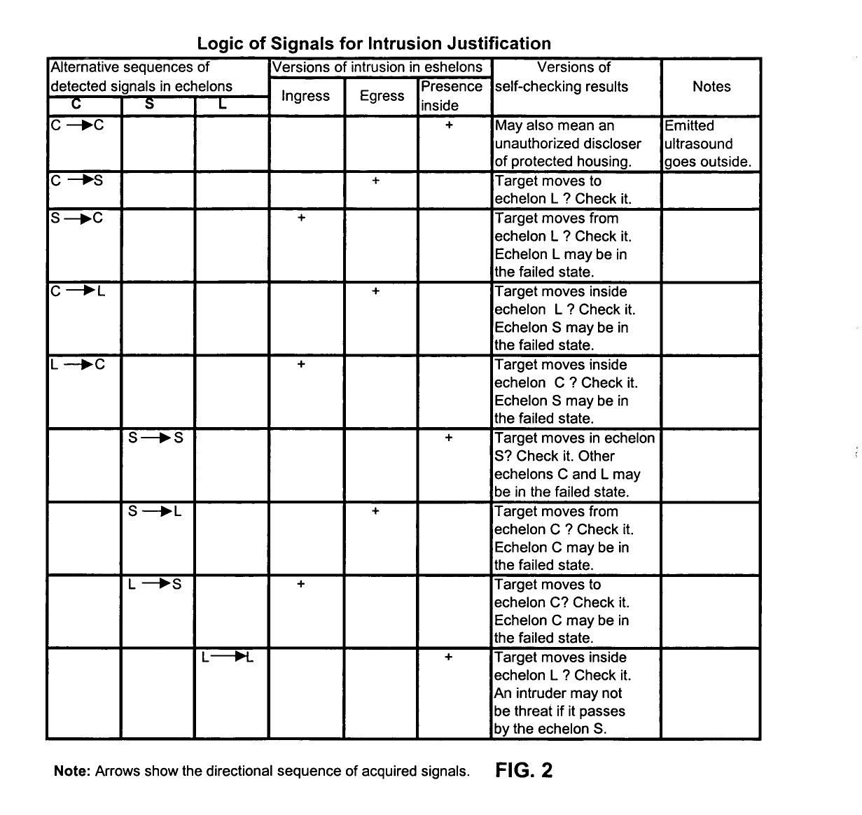

As shown at FIG. 1, the in-built echelon C is being arranged inside the enclosed housing of a protected critical installation 1. In this in-built echelon there is being used the ultrasound intrusion detection by the stationary vector directing or scan conversion techniques with reflecting and refracting response of ultrasound beams. The transmitter-receiver sets are being mounted inside the premises of this installation 1. According to the present invention, in the alternate embodiment of the method thereof, transmitters may be mounted inside premises of the installation 1 but receivers correspondingly are mounted outside these premises for detecting any breaking of their enclosures (opening doors, windows, etc.). That case the receivers may be mounted at the peripheral outline of echelon C, where the adjacent echelon S begins.

The short-range echelon S is being shaped in the form of the 2-D curvilinear or 3-D curved surface area at the direct vicinity of external peripheral outline of the enclosed housing of protected critical installation, which outline is respectively either plane or volumetric. In the short-range echelon S there is being used the ultrasound intrusion detection by the stationary vector directing technique with refracting or interference response of ultrasound beams in the result of intersecting or shielding of these beams by an intruding subject.

The at least one long-range echelon L is being arranged adjacently outside the outer peripheral outline of the short-range echelon S. In the long-range echelon L there is being used the ultrasound intrusion detection by preferably the stationary vector directing technique with reflecting response of ultrasound beams from the surface of an intruded subject.

FIG. 2 represents the logical interrelation of ultrasound detection signals acquired from different juxtaposed echelons C, S and L. The self-checking signals are being foreseen for every echelon that enables to analyze the spatio-temporal behavior of intruder and the current operational state of each surveying echelon.

### DETAILED DESCRIPTION OF THE PREFFERED EMBODIMENTS

The preferable embodiments of the present invention are being unveiled by the description of the logical interrelation of various ultrasound detection techniques that have been purposefully involved into the novel Method of Defense-in-Depth Ultrasound Intrusion Detection. The following detailed description is expected to deliver the appropriate explanation to advantages of these techniques and their beneficial interaction in ultrasound early and anticipatory intrusion detection procedure.

Let it be assumed that there exists a critical installation, which needs reliable and stealthy intrusion protection, see FIG. 1. The protection reliability is to be enabled by use of early and preventive detection of an intruder or trespasser. The secrecy, in turn, may be realized thereto by utilizing ultrasound technology for detecting the presence or motion of objects, because it is difficult to notice or suppress ultrasound waves in air without special detectors and suppressing generators respectively. The presence or motion of suspected object within a surveyed area should result in reflecting, refracting or interference of airborne narrowly directed ultrasound beams. Keeping in mind that ultrasound attenuates in air quickly enough, it seams be reasonable to arrange the whole protected room around a critical installation in several juxtaposed inside and/or outside areas, which areas represent consequently adjacent echelons of the entire defense-in-depth intrusion protection dome-shaped volumetric space. The number of echelons and their space dimensions depend upon the amount of whole protected volumetric room, the known spatial-temporal parameters of airborne ultrasound propagation and the predetermined behavior of an intruder or trespasser. The said behavior predestines correct chose of relevant ultrasonic detecting technique and instrumentation for each surveyed echelon. Consequently, the said defense-in-depth protection of the entire surveyed room is being realized with an appropriate informational interaction in logically exhaust signal processing according to the fallowing signal justification sequence:
simultaneous location inside all the echelons with forming the warning signals in case of presence or motion of suspected objects;
keeping under surveillance the motion of suspected objects throughout the adjacent echelons with forming the intrusion vindicating signals if this motion is defined as an intrusion that threatens the protected critical installation;
logically processing the warning signals and intrusion vindicating signals and releasing the alarm signal as well as necessary operation signals of protection procedure.

As it is shown at FIG. 1, the whole room around a critical object is being arranged at least in three juxtaposed areas that are defined as in-built (C), short-range (S) and long-range (L) echelons. The in-built echelon C is being arranged inside the normally enclosed premise of a protected installation 1 that optionally is placed on a supporting base 2. The inside reflecting surfaces 3 are being constructed to enclose normally said protected installation 1. At least one pair of transmitter 4 and receiver 5 is being mounted inside the enclosed area of echelon C. Over the echelon C there is being arranged the internal border 6 of the short-range echelon S. The external border 7 of echelon S is being made to coincide with the frontier 8 of open to outside the echelon L. In dependence on real volumetric shapes of surveyed echelons C, S, and L the said borders and frontier are being configured like either 2-D curvilinear array or 3-D curved spatial surfaces, or any combination thereof. The internal border 6 and external border 7 of the short-range echelon S both are being equipped with alternate pairs of transmitters 9 and receivers 10, so that all of the area of echelon S is filled with ultrasound pattern beams 11, which beams are arranged closely and directed oppositely each other. The outer surface of frontier 8 of echelon L is equipped (preferably chequerwise) with integrated transmitter-receiver transducers 12, so that a sort of umbrella barrage of emitted upstream ultrasound is being formed by closely adjacent beam patterns 13.

The principal operational character of each echelon is based upon the chosen ultrasound detecting technique. Since the echelon C is a normally enclosed premise, it is reasonable to use therein the technique of ultrasound echolocation. The narrow ultrasound beam 14 is being emitted inward the enclosed area of echelon C and consequently reflected from inner surfaces 3 in the form of a pattern lobe of returned beam 15, provided these beams should not be disturbed by the presence of an intruder. Otherwise, said pattern lobe of returned beam 15 will be changed and receiver 5 consequently will register an intrusion. If the integrity of enclosure of installation 1 was destroyed, see dashed lines at FIG. 1, (broken walls, opened doors or hatches, etc.) the emitted beam 14 or some of the reflected beams 15 should go outward in the form of released beam 16 that might be registered by one of the receivers 10 of echelon S, so in the result an ingress or aggress intrusion should be registered as well. Thus and so, inside echelon C there is being realized the couple of ultrasound techniques, namely the ultrasound echolocation and detecting of outward released airborne ultrasound by scan mode, which techniques are being designated for the local detection of ingress or aggress intrusion. So far as echelon S is being designed for perimeter protection of outside area around the installation 1, it appeared to be reasonable to use the technique of ultrasound beam interference because an expected intruder has to cross this echelon in any case on his ingress or aggress motion regarding the critical installation 1. It means that an intruded target 17 must interfere or overshadow the ultrasound beams 11 going from transmitters 9 to receivers 10 inside echelon S. At the perimeter echelon S there may be utilized the target detection with use of either stationary vector directing or scan conversion techniques where purposely selected number of receivers 10 operate in the scan mode but the rest number of receivers 10 and all the transmitters 9 operate in stationary vector directing mode. The external echelon L is being designed for protection of all the vicinity area of the critical installation 1 with the aim of early and anticipatory intrusion detection where an intruded target 18 must be found at its trajectory 19 of approaching this protected installation. Since ultrasound beams 13 of echelon L are being emitted continuously outward the frontier 8 and therefore may return only when being reflected from a random target in the form of reflected beams 20, it appeared to be reasonable to apply the technique of ultrasound beam reflection with use of either stationary vector directing or scan conversion techniques where the selected number of transmitter-receiver transducers 12 may operate in stationary vector directing mode and the rest number of said transducers may operate in the volumetric scan mode. The purposeful choice of one of said techniques and said arrangement of transmitter-receiver transducers 12 are being done in dependence of the preliminary assumed graphic-analytical model of intrusion vulnerability of the long-range echelon L. Since the behavior of target 18 inside echelon L is really crucial for all the consequent intrusion protection activity, there is being organized the estimation of the main parameters of said behavior. For example, analyzing the changes of dimension H in time and value may assess the threatening approach of target 18 to the installation 1. Optionally, Doppler detection may be used for signal processing of long-range echelon L.

According to the present invention the signal processing in echelon L, S and C is being carried out on the basis of logically exhaustive signal procedure. The basic matrix of logic analysis of combination and sequence of retrieved signals is shown at FIG. 2. This matrix enables to analyze the directional sequence of retrieved signals and to assess respectively direction, intensity and at least the real security threat of intrusion to the protected installation 1. This very analysis and assessment is being accomplished with respect to the preliminary composed the local and the generalized graphic-analytical models of intrusion vulnerability. The local graphic-analytical model is being composed in accordance with the forecasted behavior of intruder and the utilized ultrasound detecting technique as it was described here before for each echelon C, S and L. The generalized graphic-analytical model is being compiled with taking to consideration the specifity of each local model and the appropriate informational interaction among adjacent echelons in logical signal processing. In another words, the generalized graphic-analytical model is being built on the basis of variable vector of intruder's motion throughout the echelons and on the logically motivated sequence of warning, intrusion vindicating and alarm-activating signals. The table of FIG. 2 shows also the versions of self-checking results in each echelon. This functional feature of signal processing is being foreseen for enhancing the reliability of signal processing procedure itself.

The suggested by the present invention the novel method of defense-in-depth ultrasound intrusion detection enables to minimize the hardware instrumentation and to simplify the processing software, since it utilizes though different but the only ultrasound intrusion detection techniques in each echelon. It permits to meet the requirements of functional diversity and simultaneous operational reliability in various redundant trains of reliable defense-in-depth safety systems, e.g. for protection Nuclear Power Plants and other civilian and military objects. Therefore this method shall be useful and beneficially in critical intrusion protection systems.

1. Method of defense-in-depth ultrasound intrusion detection that establishes the purposeful interrelation of various techniques of ultrasound intrusion detection with the aim to ensure an early and anticipatory defense-in-depth intrusion protection throughout a multi-echelon and dome-shaped volumetric space around a surveyed critical installation.

2. Method as defined in claim 1 wherein the whole of protected dome-type volumetric room around a critical installation is being arranged in several juxtaposed areas, which areas are being defined as interrelated echelons of an entire defense-in-depth intrusion detection space.

3. Method as defined in claim 2 wherein the geometrical shapes and dimensions of said 2-D curvilinear or 3-D curved surface areas are being put in correspondence to the spatio-temporal parameters of air-borne ultrasound propagation, the presumptive spatio-temporal behavior of an intruder or trespasser, as far as to the available capabilities of covering all the said surfaces with the appropriate stationary or scanning ultrasound beam patterns during surveillance.

4. Method as defined in claims 2 and 3 wherein a proper graphic-analytical model of intrusion vulnerability for each echelon is being composed with regard to the options of supposed spatio-temporal purposeful behavior of intruder or trespasser, which graphic-analytical model is being used for verifying geometrical shape and dimensions of every echelon of said entire defense-in-depth intrusion detection space.

5. Method as defined in claims 1, 2 and 3 wherein the appropriate technique of ultrasound intrusion detection for each of said echelons is being chosen and assigned regarding the type of ultrasonic beam responding, i.e. reflection, refraction and interference, which types of ultrasonic beam responding are being respectively selected in compliance with previously composed graphic-analytical models of intrusion vulnerability for each surveyed echelon.

6. Method as defined in claims 1 and 4 wherein the generalized graphic-analytical model of intrusion vulnerability for entire protected dome-type volumetric room around a critical installation is being composed, which model is being created with the aim to establish an operatively reliable and functionally correct signal-processing interrelation amongst different adjacent echelons based on the principle of early and anticipatory ultrasound detection of ingress or aggress intrusion thereinto.

7. Method as defined in claims 1 and 6 wherein the diversity of hardware and software of all techniques of ultrasound intrusion detection involved is being minimized with the aim of consequent assembling the mutual set of instruments and prepare the appropriate software for logically exhaustive the defense-in-depth intrusion detection signal processing.
